(19) United States
(12) Patent Application Publication
(10) Pub. No.: US 2011/0273324 A1
(43) Pub. Date: Nov. 10, 2011

(54) CONTINUOUS HIGH-ACCURACY LOCATING METHOD AND APPARATUS

(75) Inventor: Jean-Paul Petillon, Miramas (FR)

(73) Assignee: EUROCOPTER, Marignane (FR)

(21) Appl. No.: 13/085,770

(22) Filed: Apr. 13, 2011

(30) Foreign Application Priority Data
Apr. 22, 2010 (FR) 10 01720

(51) Int. Cl. G01S 13/08; G01S 3/80; G01C 3/08

(52) U.S. Cl. 342/118; 356/5.01; 367/127

(57) ABSTRACT

Method and apparatus for locating an object (2) that is to be located relative to a reference object (1), by electrically generating a locating signal (SL) by modulating a carrier signal with pseudo-noise. The modulation is continuous and of the ultra-wideband (UWB) type. Analysis using a cross-correlation function between said locating signal (SL) and received reflected signals (SRR1, SRR2) serves to segregate waves that have followed a direct path and any interfering waves that have followed indirect paths, so as to be able to deduce therefrom the shortest overall propagation time corresponding to those of said locating waves (OL) that have followed direct paths. The invention applies in particular to a rotary wing aircraft, e.g. a helicopter drone.

### CROSS REFERENCE TO RELATED APPLICATIONS

This application claims the benefit of FR 10 01720 filed on Apr. 22, 2010, the disclosure of which is incorporated in its entirety by reference herein.

### BACKGROUND OF THE INVENTION

(1) Field of the Invention

In general, the present invention relates to locating an object relative to a reference.

The term “locating” is used to mean continuously determining successive positions of the object that is to be located in three-dimensional space relative to a reference object.

(2) Description of Related Art

In the examples, a description is given of continuously locating an aircraft (acting as the object that is to be located) during automatic guidance of the aircraft relative to a reference (acting as the reference object) on which the aircraft is to land.

More precisely, the problems solved by the invention are explained with reference to an example relating to a system for automatically landing a rotary wing aircraft of the helicopter drone type (also known as an unmanned aerial vehicle (UAV)). However, the invention may also be applied to guiding a manned aircraft, such as an oil rig service helicopter.

In this example, locating serves to perform remote three-dimensional guidance, enabling the aircraft to land on a ship (where the ship is the reference object). Although this guidance (without contact so long as the two objects are remote to each other) is described mainly with reference to a final landing stage, the guidance naturally also covers takeoff by an aircraft that has landed.

In order to ensure safety and practical effectiveness for such landing/takeoff, locating needs to be performed with very great accuracy, in particular accuracy of decimeter order (i.e. within 10 centimeters (cm)), relative to a reference frame that may itself be mobile (as applies to a ship).

The approach ought to terminate by an anchor arrangement (e.g. a harpoon) of the drone coupling with a complementary catcher mechanism (e.g. a grid) in the landing area of the ship.

These anchoring arrangements and catching mechanisms are of small dimensions (at present of the order of 1 meter (m). This implies very accurate and almost point-like matching in order to ensure that one catches the other.

The system must enable landing and takeoff to be safe, even in rough seas (e.g. force 5), without running any risk of an impact between the air vector (aircraft) and the sea vector.

It can thus be understood that accurate altitude locating is crucial. In order to be usable, locating in accordance with the invention must therefore be expressed in terms of coordinates along each of three orthogonal axes in an X, Y, Z frame of reference. The “elevation” Z axis generally corresponds to altitude.

At all times, locating must accommodate the mobility of the object that is to be located. Naturally, the relative mobility of the reference object must also be taken into account. In fact, the X, Y, Z frame of reference needs to be associated with the ship on which landing is to take place. In contrast, a global positioning system (GPS) serves, for example, to provide an instantaneous position for an object relative to a terrestrial frame of reference.

Another problem is that of being able to perform reliable locating of the aircraft relative to the ship on a continuous basis, i.e. at all times throughout an approach and until the aircraft has landed.

Continuity and reliability need to be independent of the environment of the approach. Unfortunately, an approach is often performed in the proximity of major sources of disturbance (e.g. interfering metal masses, other electronic systems, etc.), and sometimes under atmospheric conditions and visibility (fog, storm, ice, etc.) that are difficult.

In terms of altitude, the accuracy of GPS systems is thus not satisfactory for landing. A drawback of GPS systems is that they are designed to provide a location with accuracy of decimeter order (i.e. within 10 m). The characteristics of their signals reflects this initial choice: the width of the auto-correlation function of the precise positioning service (PPS) signal that determines resolution in three dimensions is only 30 m (3×10⁸ meters per second (m/s) per 10 megahertz (MHz)). Such a value makes it impossible to discriminate between the direct wave and a reflected wave, which may differ by 2 m or 3 m. This makes GPS systems unusable close to metal structures where multiple paths for waves are numerous.

On the same lines, aircraft guidance using inertial units is not appropriate, since that presents accuracy of kilometer order, whereas landing requires accuracy of the order of 10 cm.

As for instrument landing systems (ILS) of the kind used for airport runways, they might possibly be suitable for adapting to an aircraft carrier, but not for adapting to smaller ships that are suitable for receiving an aircraft weighing less than 1 (metric) ton (t).

Thus, for landing a rotary wing aircraft (e.g. a drone or a manned helicopter), those prior art techniques do not make it possible all along an approach to obtain accumulated angular accuracy in terms of location and guidance that are of the order of one degree of angle (1°), both in terms of elevation and in terms of relative bearing. With approach maneuvers generally beginning at a distance of the order of a few hundreds of meters, prior art techniques do not provide such accuracy.

To summarize, in order to enable rotary wing aircraft (e.g. helicopter drones) to land automatically on ships, known UAV automatic recovery systems (UARS) are not sufficiently accurate and are unsuitable for use under difficult weather conditions, and are not easy to install. Such a difficulty of installation is to be observed in particular on board ships (small footprint desired) and on board drones (low weight, size, and fuel consumption being desired).

That said, various known techniques may be mentioned for locating a vehicle, and in particular a drone.

One drone locating technique consists in using a tracking radar having a steerable motor-driven antenna. The antenna transmits a focused signal that is reflected by the drone. The radar antenna picks up this reflected signal and points at the drone. The orientation of the radar antenna gives the direction in which the drone is to be found. Measuring the propagation time of the signal between the drone and the radar antenna gives an indication concerning the distance of the drone.

That type of locating is proposed by Sierra Nevada Corporation in the document “URCARS-V2, unmanned aerial vehicle common automatic recovery system—version for shipboard operations” that is available at the following address: http://www.sncorp.com/PDFs/ATCALS/UCARS-V2%20Product%20Sheet.pdf.

Servo-mechanisms steer the radar antenna, thereby limiting tracking dynamics. The presence of moving elements increases costs, energy consumption, maintenance, reliability, and wear in such an implementation. Furthermore, the restricted possibilities for steering the antenna limits the extent of possible approaches for aircraft to a few relatively converging directions.

Conversely, one of the objects of the invention is to allow for diverging approaches of the object that is to be located, i.e. to allow for it to be able to approach or move away from its reference point in practically any direction.

Another drone locating technique is proposed by Geneva Aerospace. That technique is based on a system referred to as relative global positioning system (RGPS) that in turn makes use of the GPS system. Comparing GPS measurements taken by a GPS receiver on the aircraft with GPS measurements taken by a GPS receiver on the reference site makes it possible to reduce the error in locating the GPS receiver of the aircraft.

The main drawback of that RGPS implementation in the proximity of large metal structures is the inaccuracy induced by the presence of multiple paths, giving rise to errors of several meters. One of the objects of the present invention is to combat multiple paths.

Yet another drone locating technique is based on using images from a plurality of cameras that are mounted in a spaced-apart configuration on a reference site, so as to obtain a stereoscopic view that is suitable for locating the drone.

That technique based on cameras is unusable in the event of fog or bad weather. In addition, in order for the measurements to be sufficiently accurate, the cameras need to be widely spaced apart from one another, while nevertheless remaining accurately harmonized with one another, which is difficult to achieve in practice.

Mention is also made of documents relating to the technical field of guiding vehicles.

Document WO 2010/016029 describes a system for locating a land, air, or sea vehicle based on a carrier signal in the form of waves modulated with pseudo-noise. A propagation time and a Doppler effect offset are measured. A two-dimensional correlation is performed between a reflected signal and a reference signal replicating the waves of the carrier signal. The carrier signal is wideband, e.g. a microwave signal. That signal is reflected on structures of the vehicle, e.g. its antennas. That document does not describe modulating the carrier signal with ultra-wideband (UWB) type pseudo-noise. That document does not describe at least two receiver means dedicated to the locating waves on the reference object. That document does not describe a reference object that might itself be mobile, as is the object that is to be located. That document does not describe deducing the shortest overall propagation time corresponding to the locating wave that has followed the shortest path.

Document US 2008/062043 describes determining the position of a target object, such as an airliner. A framing function is applied repetitively to a first signal, while a second signal forming part of a pair of radio signals is received by a couple of passive sensors from the target object. Nevertheless, a time offset is applied to a framing function during a correlation time interval. Pulses received by those sensors are assumed to be direct, while other pulses that arrive later are assumed to have been subjected to multipath propagation [0025]. A correlation peak is determined, and these peaks are compared in order to determine the position of the target object. That document does not describe modulating the carrier signal with a UWB type pseudo-noise signal. That document does not describe a reference object capable of moving as well as the object that is to be located. That document does not describe an object that is to be located transmitting a reference signal. That document does not describe deducing the shortest overall propagation time corresponding to the locating wave that has followed the shortest path.

Document FR 2 836 554 describes locating a pilotless aircraft. It appears to correspond to the Hetel helicopter drone demonstrator developed by the suppliers Isnav and ECT since 1998 and presented in 2000. That document describes the use of up and down data links, preferably pre-existing links between the aircraft and ground means, e.g. situated on the deck of a boat, which data links are associated with transmitters and receivers on the ground or on the deck of said boat. The position of the helicopter is calculated from travel time difference measurements. That locating technique applies to any aircraft whether piloted or not, and in particular to unpiloted helicopters that are to land on the deck of a boat. That document does not describe modulating a carrier signal with a UWB type pseudo-noise signal.

Document US 2008/204307 describes a semiconductor device for a spread spectrum apparatus, which device is applied as from a stage of combining a carrier signal at a given frequency (radiowave) with a payload signal at a pseudo-frequency that is relatively close to that of the carrier signal. That document provides for using a spread spectrum radar to modify the linear trajectory of land vehicles in order to avoid obstacles. That document does not provide for measuring propagation times along at least two distinct wave paths.

Document EP 1 865 337 describes a spread spectrum radar appliance with a transmitter unit that generates a spread spectrum signal by using a first oscillator signal and a transmitted code PN. That apparatus is designed to modify the linear trajectory of land vehicles in order to avoid obstacles.

Document WO 2007/063126 describes a guidance system for automatic aircraft landing, using an electromagnetic detector and locating device positioned on the ground to take the measurements. The distance between the device on the ground and the aircraft, and the angular position of the aircraft relative to a reference direction are determined from the echo reflected by said aircraft in the form of a continuous sinewave.

### SUMMARY OF THE INVENTION

The present invention seeks to remedy the drawbacks of known techniques by proposing locating without having recourse to movable mechanical elements (i.e. a solid state technique) that is three-dimensional, continuous, and very accurate, in particular in terms of altitude.

To this end, the invention is defined by the claims.

For example, the invention provides a method of locating an object that is to be located relative to a frame of reference associated with a reference object. The method includes electrically generating a locating signal by modulating a carrier signal with pseudo-noise. That modulation spreads the spectrum of said locating signal, with said locating signal being transmitted in the form of locating waves using at least one wave transmitter.

Such locating waves are received and transformed into a received reflected signal in electrical form, and the received reflected signal is processed so as to determine at least one propagation time for said locating wave. The relative position of said objects is calculated on the basis of said propagation time.

In an implementation, the following steps are performed:

electrically generating said locating signal and transmitting said locating wave from the reference object, the modulation of said carrier signal with said pseudo-noise being continuous and of the ultra-wideband type;

reflecting said locating waves by reflector means situated on the object that is to be located;

receiving locating waves by at least two receiver means disposed on the reference object, each transforming the locating waves into a respective received reflected signal in electrical form;

analyzing the received reflected signals by means of a cross-correlation function between said locating signal and each of the received reflected signals, in order to segregate locating waves that have followed a direct path and any interfering locating waves that have followed indirect paths; and

deducing the shortest overall propagation time corresponding to those of the locating waves that have followed a path without interfering reflection.

In an embodiment, in order to generate the locating signal electrically by modulation, the carrier signal and the pseudo-noise signal are in the microwave electromagnetic frequency range, and the UWB type modulation possesses a relative bandwidth of the order of 0.5.

In a variant, the frequency of the carrier signal is of the order of 2.4 gigahertz (GHz), and the frequency of the pseudo-noise is of the order of 600 MHz.

In an embodiment, the locating signal also transfers information between the object that is to be located and the reference object, in particular locating information transmitted from the reference object to the object that is to be located.

In another embodiment, the locating wave is an acoustic wave, and the carrier signal and the pseudo-noise are in the ultrasound type acoustic frequency range being of the order of at 20 kilohertz (kHz).

In a variant, when the locating waves are reflected by active reflector means in the acoustic frequency range, a frequency change is performed of the locating signal in order to avoid interfering coupling by the Larsen effect.

In another implementation, the locating wave is transmitted in the form of light. For example, it may be infrared light.

The invention also provides a locating apparatus designed to implement the above-described method. In order to locate an object that is to be located relative to reference frame, it is the reference object that is associated with the reference frame.

In an embodiment, the object for locating is an aircraft, and the reference object with which said reference frame is associated is a ship. For example, they comprise respectively a helicopter drone and a ship on which said drone is to land.

In a variant, the object for locating is the center of an area for landing on the deck of a ship and the reference object associated with said reference frame is an aircraft.

In another embodiment, said reflector means are of the active type.

In yet another embodiment, said reflector means are of the passive type, in particular of the retroreflector type for a locating light-wave, or of the cube corner reflector type for a microwave electromagnetic locating wave.

In yet another variant, transmission is performed in the form of microwave electromagnetic waves.

If transmission is performed in the form of microwave electromagnetic waves, transmitters and receivers for said locating waves both on the reference object and on the object that is to be located are constituted respectively by transmitter and receiver antennas.

In another embodiment, transmission is performed in the form of acoustic waves. If transmission is performed in the form of acoustic waves, a transmitter and sensors of said locating waves on the reference object and on the object that is to be located are respectively a transmitter loudspeaker and receiver microphones.

The invention also provides an aircraft of the type designed to implement the above-described method. In one embodiment, the aircraft is a rotary wing aircraft.

### BRIEF DESCRIPTION OF THE DRAWINGS

The invention and its advantages appear in greater detail from the following description that shows an embodiment of the invention given without any limiting character, and with reference to the accompanying figures, in which:

FIG. 1 shows a reference object and an object for locating that are remote from each other, together with the components of an apparatus in a first variant of the invention;

FIG. 2 shows the stages of processing in an aircraft locating method in accordance with the invention;

FIG. 3 shows a first embodiment of reflector means mounted on board the object that is to be located, e.g. a passive reflector such as an arrangement of mutually orthogonal panels forming a kind of retroreflector;

FIG. 4 shows a second embodiment of reflector means on board the object that is to be located, e.g. an active reflector such as a repeater; and

FIG. 5 shows a reference object 1 with variant receiver means and with transmitter means.

### DETAILED DESCRIPTION OF THE PREFERRED EMBODIMENTS

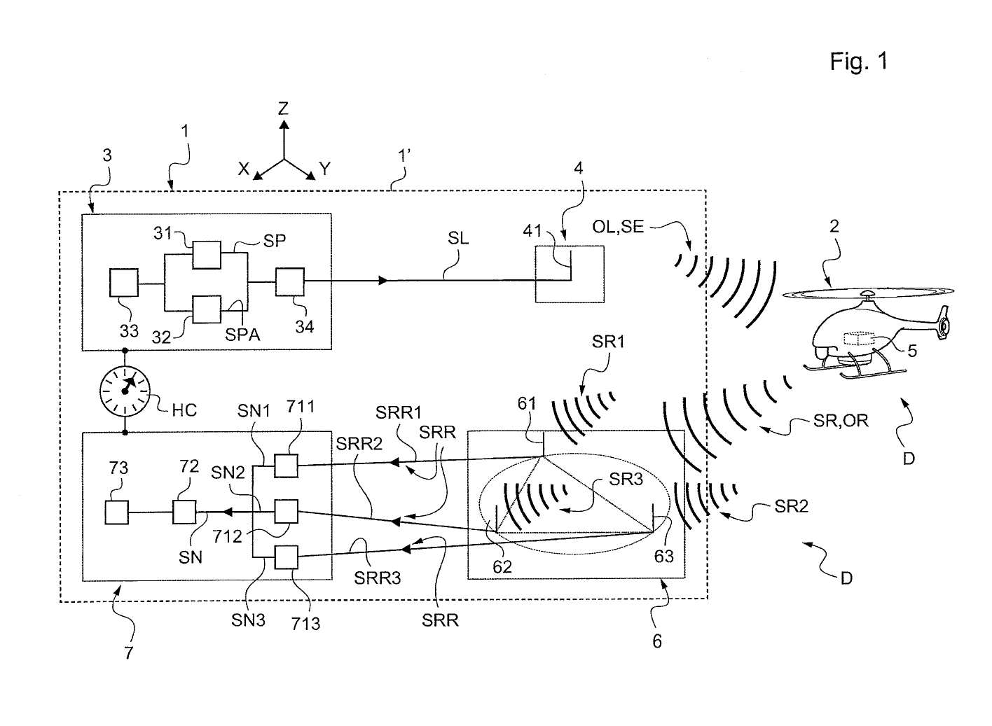

FIGS. 1 and 3 to 4, show three mutually-orthogonal axes X, Y, and Z. It should be understood that the X, Y, Z frame of reference is virtual and associated with a reference object 1, i.e. an object to be reached or constituting an origin for the object to be located.

The X axis is said to be longitudinal. Another axis, the Y axis is said to be transverse. A third axis, the Z axis, is said to be an elevation axis. In flight, changes of altitude are measured substantially along the Z axis.

FIG. 1 shows an object 2 that is to be located that is remote from the reference object 1.

Without this being limited, in the examples shown, the reference object 1 is a ship. The object 2 that is to be located is a helicopter drone in the same examples.

Naturally, the invention applies to other types of reference object 1 and object 2 that is to be located, for example a landing area on the ground (as the reference) and a fixed or rotary wing aircraft (to be located).

Below, and by way of example, it is assumed that the reference object 1 includes a landing area 1′ that may be located on the deck of a ship.

In the explanations below, the object or drone 2 is in a stage of approaching the reference object 1 in order to land on said reference object 1. Although this example of the invention is described for the final stages of landing on deck, the invention naturally also covers the aircraft taking off, i.e. the drone 2 taking off from the deck.

Still more widely, the invention relates to locating any object 2 that may be mobile relative to a frame of reference, which frame of reference may itself be static or mobile.

In this example, the invention is in the form of an apparatus D for locating the object 2 that is to be located by using receiver means 6 within the object 1.

It should be observed that the locating apparatus D is constituted by various physical and logical components, some of which form part of the reference object 1 and others form part of the object 2 that is to be located.

In FIG. 1, a portion of the apparatus D on the reference object 1 includes producer means 3 serving to produce a locating signal SL.

This portion of the apparatus D on the object A also includes transmitter means 4 with a transmitter antenna 41. These transmitter means 4 receive said locating signal SL from the producer means 3.

These transmitter means 4 broadcast a transmitted signal SE in the form of waves OL that are transmitted from the reference object 1.

By modulating a carrier signal with pseudo-noise, the spectrum of said locating signal SL is spread, which signal is transmitted continuously in the form of locating waves OL using the wave transmitter of the transmitter means 4. It should be observed that in certain embodiments of the invention, the transmitter means 4 may include a plurality of distinct locating signals and a plurality of transmitter antennas.

The transmitter signal SE in the form of waves OL is designed to be picked up by reflector means 5. The reflector means 5 form part of the locating apparatus D and they are installed on the object 2 that is to be located, i.e. a helicopter drone in FIG. 1.

Once picked up by the reflector means 5, the transmitter signal SE in turn generates a reflected signal SR. Like the transmitter signal SE, the reflected signal SR is a wave OR that is designed to be picked up by receiver means 6 on the object 1, i.e. on a ship on which the drone is to land, as shown in FIG. 1.

According to the invention, the wave OR conveying the reflected signal SR, as received by the reference object 1 at a plurality of points, is transformed into received reflected signals SRR. These received reflected signals SRR are in electrical form.

It is explained below how these received reflected signals SRR are processed in order to determine at least one propagation time for said locating waves OL. It is on the basis of such propagation times that the instantaneous relative position of said objects 1 and 2 is calculated.

For this purpose, the receiver means 6 pick up a reflected signal SR, and analyzer means 7 respond to the reflected received signals SRR to determine the coordinates of the position of the object that is to be located.

In FIG. 1, the producer means 3 comprise an oscillator 31 generating a carrier signal SP as a sinewave, i.e. a periodical signal. In certain embodiments, the oscillator 31 is a voltage controlled oscillator (VCO).

The producer means 3 also include a pseudo-random frequency generator 32 that prepares a pseudo-random sequence referenced SPA in FIG. 1. The pseudo-random frequency SPA is periodic, but it presents properties that are close to the properties of a random sequence, hence the term “pseudo-random” sequence. It is made up of a predefined sequence of binary digital states.

Still with reference to FIG. 1, the producer means 3 include a reference clock 33 for synchronizing the analyzer means 7 (as represented by HC). The analyzer means 7 are in turn connected to receive the received reflected signals SRR from the receiver means 6. The analyzer means 7, the transmitter means 4, and the receiver means 6 are mutually synchronized.

In FIG. 1, the voltage controlled oscillator 31 and the pseudo-random sequence generator 32 are servo-controlled to the reference clock 33. As a result, the carrier signal SP and the pseudo-random sequence SPA present a constant phase offset in time, thereby ending up by producing a “coherent” locating signal SL.

The producer means 3 shown in FIG. 1 comprise a mixer 34 that modulates the carrier signal SP with the pseudo-random sequence SPA. As a result, the locating signal SL presents a spectrum that is spread in the frequency domain.

According to the invention, crossed-correlation processing serves to calculate the time offset of the locating signal relative to the received reflected signal SRR with improved peak-separation power resulting from the ultra-wideband.

In the context of the invention, the self-correlation peak is narrow because of the wide band of the pseudo-noise modulation.

It can be understood that, in various embodiments of the invention, the carrier signal SP, the locating signal SL, the transmitted signal SE, the reflected signal SR, and the received reflected signal SRR may be signals of various types.

In one embodiment, the locating waves are of an acoustic kind. They are reflected by the object 2 (the drone in FIG. 1) by reflector means 5 that are active in the acoustic frequency range. Thus, it is possible when necessary to change frequency within the locating signal SL, so as to avoid interfering coupling by the audio feedback or “Larsen” effect.

In another embodiment, the locating waves are of an electromagnetic kind. In order to generate the locating signal SL electrically by modulation, the carrier signal and the pseudo-noise then lie in the microwave band.

In a variant, the frequency of the carrier signal is of the order of 2.4 GHz and the frequency of the pseudo-noise is of the order of 600 MHz. Under such circumstances, ultra-wideband type modulation possesses a relative bandwidth of about 0.5.

As mentioned, the reflected signal SR may serve as a data link, serving also to convey information between the object 2 that is to be located and the reference object 1. Specifically, this locating information transmitted from the reference object 1 to the object 2 for locating may contribute to guidance.

In yet another embodiment, the locating wave OL is transmitted in the form of light. For example it may be infrared light.

In an embodiment in which the waves are acoustic, in order to generate the locating signal SL electrically by modulation, the carrier signal and the pseudo-noise signal are in the ultrasound type acoustic frequency range, i.e. they are of the order of at least 20 kHz.

In a first variant embodiment of the apparatus D, the receiver means 6 comprise at least two receiver members 61 and 63. In FIG. 1, there are three receiver members 61, 62, and 63 in the form of antennas connected to the reference object 1.

In certain embodiments, the antennas 61-63 of the receiver means 6 are planar antennas. The phase centers of the three receiver antennas 61-63 are not in alignment.

In order to ensure sufficient accuracy, the receiver antennas 61, 62, and 63 need to be sufficiently spaced apart from one another. The size of this spacing is determined by optimizing the sensitivity of the apparatus D and in order to minimize dilution of positioning accuracy.

These phase centers of the three receiver antennas 61, 62, and 63 define an equilateral triangle in FIG. 1.

In FIG. 1 and when using microwave electrical waves, e.g. at 2.4 GHz, the circle circumscribing the equilateral triangle presents a diameter of about one meter.

However with other wavelengths, the optimum value for the diameter is different. With frequencies that are much higher, e.g. several tens of gigahertz, a diameter of 200 millimeters (mm) suffices for locating with quality that is suitable for landing on deck.

Since the apparatus of the invention is based on propagation time measurements, the transmitter antenna 41 and the receiver antennas 61, 62, and 63 may be designed to have radiation patterns that are very wide without degrading performance. The apparatus may also operate over a range of operating angles that is very large and there is no need to have recourse to preliminary pointing.

For reasons of compactness, the transmitter antenna 41 is situated close to the receiver members 61, 62, and 63. In practice, a configuration is selected that optimizes altitude accuracy dilution in order to minimize location errors along the Z axis.

In FIG. 1, the phase center of the transmitter antenna 41 is advantageously situated at the center of gravity of the equilateral triangle defined by the phase centers of the three receiver antennas.

In this figure, the analyzer means 7 comprise three analog-to-digital converters 711, 712, and 713 serving, after a treatment stage referred to as frequency-changing, to convert each of the received reflected signals SRR, respectively.

Thus, these received reflected signals SRR are in analog form, SRR1, SRR2, and SRR3, since they come from receiver antennas 61, 62, and 63, respectively. They are converted into digital signals SN, respectively SN1, SN2, and SN3. The purpose of this conversion is naturally to be able to process them subsequently using computer means (forming part of the analyzer means 7 in FIG. 1).

Thereafter, a digital correlator 72 determines the propagation time for each of the received reflected signals SRR1, SRR2, and SRR3. Finally, a navigator 73 uses the various propagation times determined by the digital correlator 72 to calculate a solution for the position coordinates of the vehicle that is to be located, i.e. the aircraft 2. Optionally, the navigator 73 also calculates a position-error covariance matrix.

In certain embodiments, as mentioned above, in the portion of the locating apparatus D of the invention that is incorporated in the vehicle 2 that is to be located, there are reflector means 5 of the passive type. Passive reflectors do not require a transmitter source and they make use of reflection abilities in the selected spectrum (visible, near-infrared, infrared, or microwave).

The reflector means 5 then act as a retroreflector for a light locating wave OL. Similarly, other reflector means 5 of passive type comprise a cube corner reflector acting in a similar manner on an electromagnetic locating wave (OL) in the microwave frequency band.

When the locating apparatus D is suitable for emitting electromagnetic microwaves OL, the transmitters and the receivers of these waves OL on the reference object 1 and on the object 2 for locating are respectively transmitter and receiver antennas.

In contrast, when the locating apparatus D is appropriate for emitting acoustic waves OL, an emitter and sensors of such locating waves OL comprise a transmitting loudspeaker and receiving microphones located respectively on the reference object 1 and on the object 2 for locating.

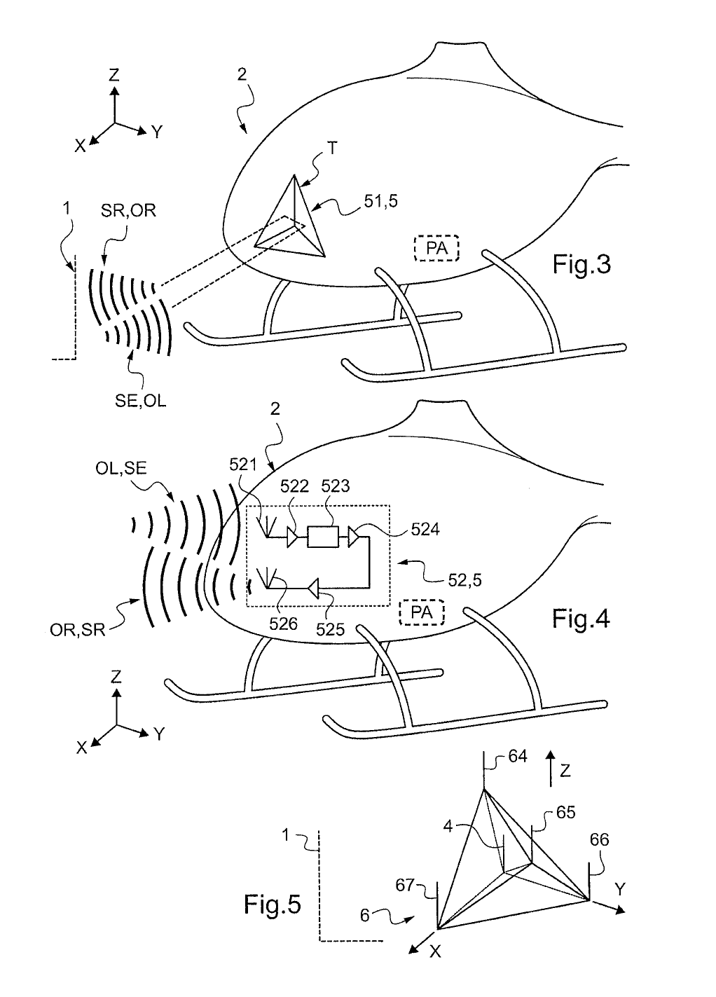

In FIG. 3, a first embodiment of the reflector means 5 comprises a passive reflector 51, i.e. an assembly of three conductive faces that are perpendicular to one another in pairs and that have the ability to reflect a signal back along its direction of arrival. In this example, the transmitted signal SE coming from the reference object 1 is thus reflected by the on-board reflector 51 in the form of a reflected signal SR comprising waves OR propagating in the direction from which the transmitted signal SE (waves OL) arise. The reflector 51 forms a set of three reflective surfaces placed at right angles so as to form a trihedron T.

FIG. 4 shows a second reflect of the reflector means 5, in the form of an active reflector of the repeater type 52.

It may also be advantageous for the trajectory of the object 2 to be capable of being modified without external intervention, so that the final approach and landing take place automatically.

Under such circumstances, it is necessary to transmit information to the vehicle 2 so that an autopilot (PA in FIGS. 3 and 4) in the object 2 can evaluate the position of the landing area 1′ and thus the direction to follow. By way of example, this information gives the position and the attitude angles of the landing area 1′ when the landing area is situated on a moving ship. Still by way of example, information may be transmitted concerning weather phenomena such as cross-winds, should that be necessary. This type of information may be sent to the object 2 by being combined with the transmitted signal SE; which signal is received by the active reflector of the repeater type 52.

In the example of FIG. 4, the repeater 52 comprises a receiver antenna 521 for picking up the transmitted signal SE (waves OL) together with an amplifier 522 and a bandpass filter 523 serving to select only the useful frequency band. In addition, the repeater 52 includes automatic gain control 524. As a result, the reflected signal SR (waves OR) that is retransmitted at the outlet from the repeater 52 presents power that is constant, regardless of the distance between the objects 1 and 2.

The term “up” data is used in embodiments where the repeater 52 also acts as a data link system. Said up data is collected at the outlet from the automatic gain control 524 by on-board systems (not shown). The repeater 52 also includes a transmitter antenna 526 that retransmits the signal SE, possibly after changing frequency, thereby generating the reflected signal SR in the form of waves OR.

It should be recalled that this data link role does not lie at the heart of the invention, even though it is useful in practice. An active reflector can thus receive the transmitted signal SE and can retransmit a reflected signal SR while in the process collecting information that is useful for carrying out the mission.

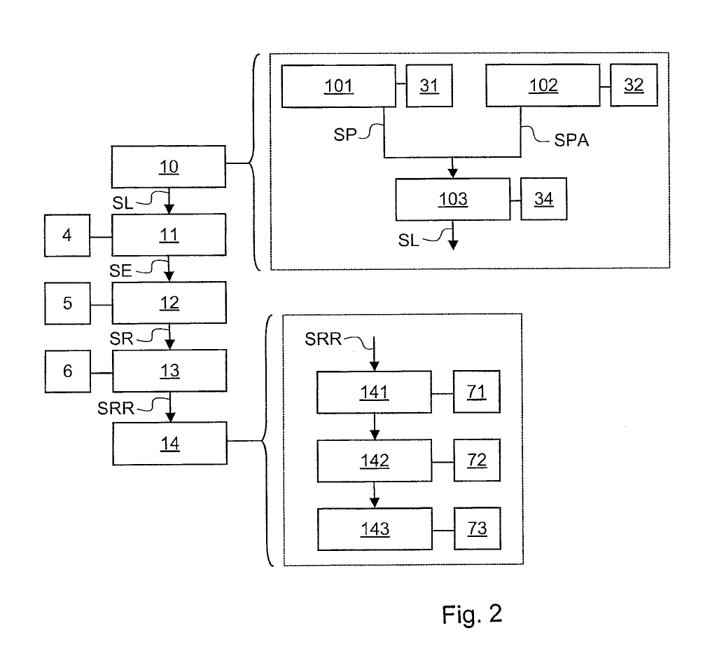

FIG. 2 shows an example of the locating method as implemented by the apparatus D of the invention.

In summary, the method makes provision for:

electrically generating said locating signal SL and transmitting said locating wave OL from the reference object 1, the modulation of said carrier signal with said pseudo-noise being continuous and of the ultra-wideband (UWB) type;

reflecting said locating waves OL by reflector means 5 situated on the object 2 that is to be located;

receiving locating waves OL by at least two receiver means 6 disposed on the reference object 1, these means 6 each transforming the locating waves OL into a respective received reflected signal (SRR1, SRR2, etc.) in electrical form;

analyzing the received reflected signals by means of a cross-correlation function between said locating signal SL and each of the received reflected signals, in order to segregate locating waves that have followed a direct path and any interfering locating waves that have followed indirect paths; and

deducing the shortest propagation time corresponding to those of the locating waves OL that have followed a path without interfering reflection.

Generally speaking, the reference object 1 and the object 2 that is to be located are moving relative to each other. Under such conditions, it is considered by way of example, although not exclusively, that the object 2 is in an approach stage in order to land on a landing area 1′, e.g. when the object 2 is situated at an approximate distance of less than 200 m from the landing area 1′.

Before this final approach stage or away from the immediate proximity of the reference object 1, the position of the object 2 may be determined by conventional means such as a GPS system or an inertial unit. These means provide accuracy that is sufficient when the object 2 is far away from the landing area 1′, but that is found to be insufficient, specifically when the object 2 begins its final approach stage. As from the final approach stage, the position of the object 2 needs to be located with greater accuracy, of the order of about ten centimeters, until landing has taken place fully on the landing area 1′.

When the object 2 is in the final approach stage, the locating method of the invention may begin.

In accordance with the invention, locating relative to the reference object 1 is based on measuring go-and-return propagation times of a signal: a locating signal is transmitted from the reference object 1, and is picked up by the object 2 that returns it with negligible delay, such that it can be picked up in turn by the reference object 1. Measuring a plurality of propagation times for the locating signal makes it possible to define the position of the object 2 relative to a reference frame associated with the reference object 1.

In the stage 10 for producing the locating signal SL of ultra-high frequency (UHF) electrical type, a voltage controlled electrical oscillator 31 generates a carrier signal SP in the generator stage 101. The carrier signal SP is of the electromagnetic type in the radiofrequency band (e.g. at 2.4 GHz) so as to have a wavelength that is small enough to enable the object 2 to be located with the required accuracy. Advantageously, and in order to minimize the amount of power transmitted on harmonic frequencies, the carrier signal SP is a sinewave.

Although there is no completely direct connection between the wavelength and the accuracy with which locating is performed, since it is entirely possible to make measurements with accuracy of the order of a fraction of a wavelength, it can be assumed, approximately speaking, that if the carrier signal SP has a frequency of about 2.4 GHz, i.e. a period of 0.42 nanoseconds (ns), then it is possible to obtain echo resolution that is substantially of decimeter order, and specifically about 125 mm (wavelength equal to 0.4210⁻⁹×3×10⁸, where 3×10⁸ is the speed of light in meters per second). This accuracy corresponds to the accuracy needed for landing the object 2.

The pseudo-random sequence SPA is generated by a pseudo-random sequence generator 32 in the processor stage 102. The pseudo-random sequence SPA has a structure that is selected so that its self-correlation function presents only one peak.

Furthermore, opting for aggressive spectrum spreading (UWB) leads to said peak having greater acuity. It is explained below that the locating signal retransmitted by the aircraft is cross-correlated with a replica of the pseudo-random sequence SPA. The pseudo-random sequence SPA has an auto-correlation function that presents only a narrow peak, so this gives rise to high separation power between the direct signal and the echoes.

By way of example, the pseudo-random sequence generator 32 has two identical circuits, each made up of:

a ten-stage shift register;

a multiplier for multiplying the 10-bit word contained in the register by a polynomial; and

a parity generator acting on the results generated by said multiplier, and having its output connected to the input of the first of the ten stages of the shift register.

The outputs from the two circuits are combined by an “exclusive-or” logic operator and the output thereof constitutes said pseudo-random sequence SPA.

The pseudo-random sequence generator 32 thus has two polynomials, thereby giving greater freedom for adjustment purposes and enabling a sequence to be selected that presents interfering secondary peaks that are very small in its auto-correlation function.

By way of example, the resulting pseudo-random sequence contains a sequence of 1023 binary values, each binary value being generated at a clock frequency of 600 MHz as imposed by the reference clock 33. The complete pseudo-random sequence thus has a duration of:

$$1023 \times \frac{1}{600 \times {10}^{6}} = 1.705 microseconds ( μ s )$$

A high clock frequency of about 600 MHz nevertheless makes it possible to have a sequence that is long enough to guarantee a measurement that is not ambiguous over the entire extent of the approach stage. The auto-correlation function has the same period as the locating signal SL, i.e. 1.705 ps, giving a wavelength of the order of 500 m (the product: 1.705×10⁻⁶×3×10⁸). Taking account of the fact that the travel time of the wave corresponds to twice the distance that is to be measured, it can be seen that the desired range is indeed less than half of this wavelength (½×500 m>200 m).

Below, it is shown that the locating signal as retransmitted by the object 2 is digitized prior to being analyzed and compared with a replica of the pseudo-random sequence. This digitizing is performed by means of an analog-to-digital converter that takes regular samples.

In order to calculate the cross-correlation functions between the received signals SRR and the locating signal SL, the analog-to-digital converters need to operate at a sampling rate of the order of twice 600 MHz, i.e. 1200 MHz.

In a modulation processing stage 103, a mixer 34 modulates the carrier signal SP with the pseudo-random signal SPA. This modulation consists merely in obtaining the product between the carrier signal SP and the pseudo-random sequence SPA.

This ordinary multiplication in the time domain corresponds to a convolution product in the frequency domain.

The convolution product of the carrier signal

SP with the pseudo-random sequence SPA thus leads to the energy of the carrier signal SP being spread over a bandwidth equal to the bandwidth of the pseudo-random signal SPA.

In an embodiment, the bandwidth of the pseudo-random sequence (2×600 MHz), expressed as a percentage of the carrier frequency SP (2.4 GHz) is of the order of 50%.

This aggressive spectrum spreading serves to obtain a narrow width for the correlation peak, so as to guarantee that the invention can resolve and reject multiple paths. It is thus possible to reduce the risk of interference with received signals that are the results of echoes on reflecting surfaces, referred to by the term “multipath” signals.

An advantage of the spectrum spreading technique is that its low spectral power density makes it more difficult to detect. This guarantees that the locating signal SL is discrete to some extent.

In a transmitter stage 11, the locating signal SL is transmitted in the form of a wave OL by the transmitter means 4, thereby generating the transmitted signal SE.

In a reflector stage 12, the transmitted signal SE is reflected by reflector means 5, thereby generating a reflected signal SR.

In a receiver stage 13, the reflected signal SR is picked up by the receiver members (e.g.: 61, 62, and 63). Each receiver member receives a respective reflected signal (e.g.: SR1, SR2, and SR3) and generates a respective received reflected signal (e.g.: SRR1, SRR2, and SRR3).

An analyzer stage 14 for analyzing the reflected signal comprises a succession of processor stages 141, 142, and 143.

In this analyzer stage 14, the reflected signals SRR1, SRR2, and SRR3 as received by the receiver members (e.g.: 61, 62, 63) are processed to calculate the propagation times, and then the position coordinates of the object 2.

For this purpose, the received signals are not digitized directly. They are initially shifted into baseband by a frequency-changer stage that converts each received signal into an in-phase signal (I) and a quadrature signal (Q). Thus, the received reflected signals SRR1, SRR2, and SRR3 (of analog origin) are converted into the following digital signals SN1_I, SN1_Q, SN2_I, SN2_Q, SN3_I, and SN3_Q in a frequency-changer and converter stage 141.

This conversion is performed by means of an analog-to-digital converter 71.

The sampling and the analog-to-digital conversion of the signals may be performed continuously. However, it may be advantageous to group the samples together into successive batches corresponding to the duration of one period of the pseudo-random sequence SPA. Such batches follow one another at a rate 600 MHz/1023≈600,000 batches per second. Performing cross-correlation on each of these batches exceeds the processing capacities of present-day circuits, however it is acceptable to process only one in every thousand, for example, in order to end up with a sampling of the trajectory at 600 Hz, a frequency which usually greatly exceeds that which is required for picking up all of the movements of the object that is to be located.

In a cross-correlation stage 142, the various propagation times are calculated by means of a digital correlator 72.

Each of these received reflected signals SRR1, SRR2, and SRR3 is converted into respective digital signals SN1 I&Q, SN2 I&Q, and SN3 I&Q. The propagation time of each reflected signal SR1, SR2, and SR3 is calculated by the cross-correlation of each digital signal SN1 I&Q, SN2 I&Q, SN3 I&Q with a replica of the pseudo-random sequence SPA. This operation is performed by means of a digital correlator 72 in the correlation processor stage 142.

Thus, the analysis by the means 7 of the cross-correlation function between each of the digital signals SN1, SN2, SN3 and the pseudo-random sequence SPA serves to calculate the propagation times τ1, τ2, τ3 for each of the reflected signals, respectively: SR1, SR2, and SR3.

One of the objects of the invention is to achieve high separation power making it possible to distinguish between a direct wave and a reflected wave. This is obtained by reducing the width of the correlation peak. To do this, the invention relies on recent technologies that make it possible to increase the carrier frequency and also the pseudo-noise frequency by a selected ratio, and on the technology of digital processing. The limiting factor or bottleneck nevertheless remains the correlator. The two opposing factors in the compromise are as follows: i) the transmitted radiofrequency (RF) power which it is desired to have as small as possible, and ii) the cross-correlation rate that must remain small enough to be compatible with the capacities of the processor circuits available on the market. A fast correlator makes a high measurement rate possible, which in turn provides an averaging effect on the noise and thus leads to an improvement in the signal-to-noise ratio, or to a reduction in the required transmitter power.

In a variant, in the analyzer stage 14, cross-correlation is performed between the received signals in pairs rather than in the received signals and a replica of the transmitted signal. This measures propagation time differences rather than absolute propagation times.

In a variant, only two antennas are used in order to simplify the apparatus D. The apparatus can then only measure a “2D” position. If the two receiver antennas lie in the same horizontal plane, then the apparatus D serves to measure horizontal position. Under such circumstances, with the object 2 having on-board equipment for determining its own altitude (e.g. a radio altimeter), it is possible to make use of that equipment in order to determine the missing coordinate.

In a navigation stage 143, a navigator 73 calculates the position coordinates of the object 2 in a frame of reference associated with the reference object 1.

When the propagation times are determined for each of the reflected signals SR1, SR2, and SR3 in the form of three time constants respectively written τ1, τ2, and τ3, said navigator 73 calculates a solution for the position coordinates of the object 2 in the navigation processor stage 143. This stage solves a system of equations as shown in the following example:

C·(τ1−Δτ)=\sqrt{x²y²z²}+{square root over (x−x1)²+(y−y1)²+(z−z1)²)}

C·(τ2−Δτ)=\sqrt{x²y²z²}+{square root over (x−x2)²+(y−y2)²+(z−z2)²)}

C·(τ3−Δτ)=\sqrt{x²y²z²}+{square root over (x−x3)²+(y−y3)²+(z−z3)²)}

In this example equation system:

C: the speed of light;

(x1, y1, z1), (x2, y2, z2), (x3, y3, z3): the coordinates of the respective receiver antennas 61, 62, and 63);

(x, y, z): the looked-for solution, i.e. the position coordinates of the object 2 in a frame of reference associated with the reference object 1; and

Δτ: the sum of the various interfering delays, in particular including the time taken to pass through the receiver and the cabling present on board the reference object 1.

In this example, the transmitter antenna of the means 4 is selected as the origin of the coordinates (0, 0, 0).

A system of three equations in three unknowns is thus available. It may be solved digitally, e.g. by using the Newton-Raphson method.

The propagation time measurements τ1, τ2, and τ3 may suffer from accuracy error, and the navigator 73 may optionally determine the quality of the error by calculating, in parallel with the above system of equations, the sensitivity matrix of the position to distance measurement errors:

$$[ \begin{matrix}\partial x / \partial τ 1 & \partial y / \partial τ 1 & \partial z / \partial τ 1 \\ \partial x / \partial τ 2 & \partial y / \partial τ 2 & \partial z / \partial τ 2 \\ \partial x / \partial τ 3 & \partial y / \partial τ 3 & \partial z / \partial τ 3\end{matrix} ]$$

On the basis of a priori knowledge of the covariance matrix for errors affecting τ1, τ2, and τ3, the navigator 73 can calculate the covariance matrix, which is variable as a function of the position of the object 2, and can thus access the “a priori” statistics concerning the error affecting the position solution.

Naturally, the present invention may be subjected to numerous variants as to its implementation. Although several embodiments are described above, it will readily be understood that it is not conceivable to describe them exhaustively. It is naturally possible to envisage replacing any of the described processor stages or means by an equivalent, without thereby going beyond the ambit of the present invention.

For example, it is clear in this respect that certain variant embodiments could have some number of receiver members that is greater than three, occupying specific positions relative to one another that are different from those described, with this continuing to be true regardless of the number thereof.

Furthermore, the invention relates equally well specifically to locating an aircraft 2 (e.g. a drone or a manned aircraft) in order to ensure its final approach and landing on the reference object 1, and to securely piloting an aircraft relative to an reference object 1, but without that leading to the aircraft landing.

In certain situations, the object to be located is a landing zone and the reference object is an aircraft.

Naturally, the invention may apply to any vehicle other than aircraft, even if it is particularly well adapted to helicopters and the like.

In addition, and where necessary, the apparatus D could be transformed at least in part by symmetry, in the sense that the object 2 that is to be located becomes the reference object 1, and vice versa, regardless of their respective types.

The apparatus D may also be duplicated, so as to provide it with redundancy, either by implementing different frequencies, or preferably by implementing mutually orthogonal pseudo-random codes. The object of such redundancy is to increase operating safety.

Before concluding, we return to the ways in which the invention differs in particular from a GPS system, i.e. the following specific features:

1) With the invention, spectrum spreading is much more “aggressive”, e.g. 2×600 MHz as compared with 2×10 MHz for the military GPS service. This makes it possible to improve separating power in a ratio of 0.5 m to 30 m. It is thus possible to distinguish between echoes and the direct wave, which is not possible with GPS-based systems.

It should be observed that this separating power is not directly equal to accuracy. It is thus possible to interpolate within a range of 0.5 m.

2) In apparatus in accordance with the invention, the wave paths all comprise a go-and-return trip between the reference and the object 2 to be located. This is essential in order to obtain good radial accuracy, while the object 2 lies well outside the constellation of receiver members of the reference. This is a second important point, which makes it possible to use a constellation of antennas that is compact and easy to install on board a ship (the three antennas may occupy a small area, of square meter order).

3) A corollary of the above is that the transmitter means 4 and the receiver means 6 are side by side, thereby eliminating transmit/receive clock bias. Compared with a GPS receiver that requires four satellites in order to solve for position and handle its clock bias, this has the advantage that the invention requires only three wave paths. In order to achieve good three-dimensional (3D) locating, and in particular in order to obtain good accuracy in terms of elevation and relative bearing, it is conventional to use extremely accurate measurements of differences between the so-called “pseudo-range” propagation times. In order to mitigate this point, the invention proposes two main variants:

one performs cross-correlations between the transmitted signal and each of the received signals, only; or the other also performs cross-correlations between each of the received signals in pairs, so as to obtain information concerning propagation time differences (also known as “delta-range” differences), and thus concerning the elevation and relative bearing angles.

What is claimed is:

1. A method of locating an object that is to be located relative to a frame of reference associated with a reference object, the method including electrically generating a locating signal by modulating a carrier signal with pseudo-noise, this modulation spreading the spectrum of said locating signal, said locating signal being transmitted in the form of locating waves using at least one wave transmitter, such locating waves being received and transformed into a received reflected signal of electrical form, the received reflected signal being processed so as to determine at least the propagation time of said locating wave, which propagation time is used to calculate a relative position for said objects;
wherein the method comprises the following steps:
electrically generating said locating signal and transmitting said locating wave from the reference object, the modulation of said carrier signal with said pseudo-noise being continuous and of the ultra-wideband (UWB) type;
reflecting said locating waves by reflector means situated on the object that is to be located;
receiving locating waves by at least two receiver means disposed on the reference object, each transforming the locating waves into a respective received reflected signal in electrical form;
analyzing the received reflected signals by means of a cross-correlation function between said locating signal and each of the received reflected signals, in order to segregate locating waves that have followed a direct path and any interfering locating waves that have followed indirect paths; and
deducing the shortest propagation time corresponding to those of the locating waves that have followed a path without interfering reflection.

2. A locating method according to claim 1, wherein in order to generate the locating signal electrically by modulation, the carrier signal and the pseudo-noise signal are in the microwave electromagnetic frequency range, and the UWB type modulation possesses a relative bandwidth substantially equal to 0.5.

3. A locating method according to claim 2, wherein the frequency of the carrier signal is substantially equal to 2.4 GHz, and the frequency of the pseudo-noise is substantially equal to 600 MHz.

4. A locating method according to claim 2, wherein the locating signal conveys information between the object that is to be located and the reference object, in particular locating information transmitted from the reference object to the object that is to be located.

5. A locating method according to claim 1, wherein in order to generate the locating signal electrically by modulation, the carrier signal and the pseudo-noise lie in the acoustic frequency range of the ultrasound type, being equal to at least about 20 kHz.

6. A locating method according to claim 1, wherein when the locating waves are reflected by active reflector means in the acoustic frequency range, a frequency change is performed within the locating signal in order to avoid interfering coupling by the Larsen effect.

7. A locating method according to claim 1, wherein the locating wave is transmitted in the form of light.

8. A locating apparatus for locating an object that is to be located relative to a frame of reference associated with a reference object, wherein the locating apparatus is designed to implement the method according to claim 1.

9. A locating apparatus according to claim 8, wherein the object for locating is an aircraft, and the reference object with which said reference frame is associated is a ship.

10. A locating apparatus according to claim 9, wherein the object for locating is the center of an area for landing on the deck of a ship and the reference object associated with said reference frame is an aircraft.

11. A locating apparatus according to claim 8, wherein said reflector means are of the active type.

12. A locating apparatus according to claim 8, wherein said reflector means are of the passive type, in particular of the retroreflector type for a locating light-wave, or of the cube corner reflector type for a microwave electromagnetic locating wave.

13. A locating apparatus according to claim 8, wherein when transmission is performed in the form of microwave electromagnetic waves, transmitters and receivers for said locating waves both on the reference object and on the object that is to be located are constituted respectively by transmitter and receiver antennas.

14. A locating apparatus according to claim 8, wherein when transmission is performed in the form of acoustic waves, a transmitter and sensors of said locating waves on the reference object and on the object that is to be located are respectively a transmitter loudspeaker and receiver microphones.

15. An aircraft of the type for implementing the method according to claim 1, wherein the aircraft is a rotary wing aircraft.
